(19) United States
(12) Patent Application Publication
(10) Pub. No.: US 2003/0219165 A1
(43) Pub. Date: Nov. 27, 2003

(54) Image processing apparatus, image processing method and image storing method

(75) Inventor: Atsushi Sakurai, Shizuoka-ken (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/413,587

(22) Filed: Apr. 15, 2003

(30) Foreign Application Priority Data
Apr. 18, 2002 (JP) 2002-116439

(51) Int. Cl. G06K 9/36; G06K 9/32

(52) U.S. Cl. 382/248; 382/298

(57) ABSTRACT

The image conversion means converts the frequency of a document image, extracts the DC component and AC component, compresses the DC component and AC component, relates the compressed DC component and AC component to each other, and stores them in the memory. The image conversion means extends the DC component stored in the memory, displays it as a thumbnail image, retrieves images, composes the DC component of a desired image and the AC component related to it, and displays a document image.

### CROSS-REFERENCE TO RELATED APPLICATIONS

This application is based upon and claims the benefit of priority from the prior Japanese Patent Application No. 2002-116439, filed on Apr. 18, 2002 the entire contents of which are incorporated herein by reference.

### BACKGROUND OF THE INVENTION

1. Field of the Invention

The present invention relates to an image processing apparatus, an image processing method, a display method and a storing method

2. Description of the Related Art

There is thumbnail retrieval available as a conventional image retrieval method.

The method separately stores thumbnail images obtained by performing an imaging operation such as compression and reduction respectively to a plurality of document images stored in a storage device such as a hard disk drive.

Each thumbnail image is related to its original document image.

When selecting a desired image from the document image group storing it, it is convenient to display many images on a display unit such as an operation panel at one time.

In this case, when a process of reduction is to be performed for each of document images of a large data size, it requires a lot of time to display many images.

Therefore, an art of sending a thumbnail image, which is reduced, compressed, and stored beforehand, to a VRAM in place of document images, displaying it on a display unit, thereby shortening the reading time due to a small data size, reducing the time required from an imaging operation, shortening the display waiting time, and realizing comfortable retrieval is disclosed in Japanese Patent Publication No. 2-206873.

When a thumbnail image, which is a converted desired document image, is found, the document image can be taken out easily because it is related to. The document image is sent to a page memory and printed.

However, according to this method, it is necessary to store the thumbnail image together with the document image and a storage device having a larger storage capacity must be prepared.

Further, the data transfer amount is increased in correspondence to the thumbnail image, and the load on the system is increased, thus it is difficult to perform comfortable image retrieval.

Furthermore, there are other load factors such as data transfer between the page memory and the VRAM and the equipment constitution round the data bus is apt to be complicated and increased in size.

### BRIEF SUMMARY OF THE INVENTION

The present invention is intended to provide an image processing apparatus capable of performing comfortable image retrieval and provide an image processing apparatus having a simplified equipment constitution round a data bus.

The present invention provides an image processing apparatus having an image input means for inputting an image, an image conversion means for converting the frequency of the input image and extracting the DC component and AC component thereof, a compressing means for compressing the DC component and AC component, a storing means for storing the compressed DC component and AC component related to each other, an extending means for extending the stored DC component and AC component, a first display means for displaying the DC component as an image, and a second display means for composing and displaying the DC component and AC component as an image.

### BRIEF DESCRIPTION OF THE DRAWINGS

FIG. 1 is a block diagram showing an image forming apparatus according to an embodiment of the present invention;

FIG. 2 is a flow chart of an image storing process;

FIG. 3 is a flow chart for displaying a thumbnail;

FIG. 4 is a flow chart of a process of displaying stored images as thumbnail images, retrieving a desired image, and printing it; and

FIG. 5 is a block diagram of the internal structure of a computer according to the second embodiment of the present invention.

### DETAILED DESCRIPTION OF THE INVENTION

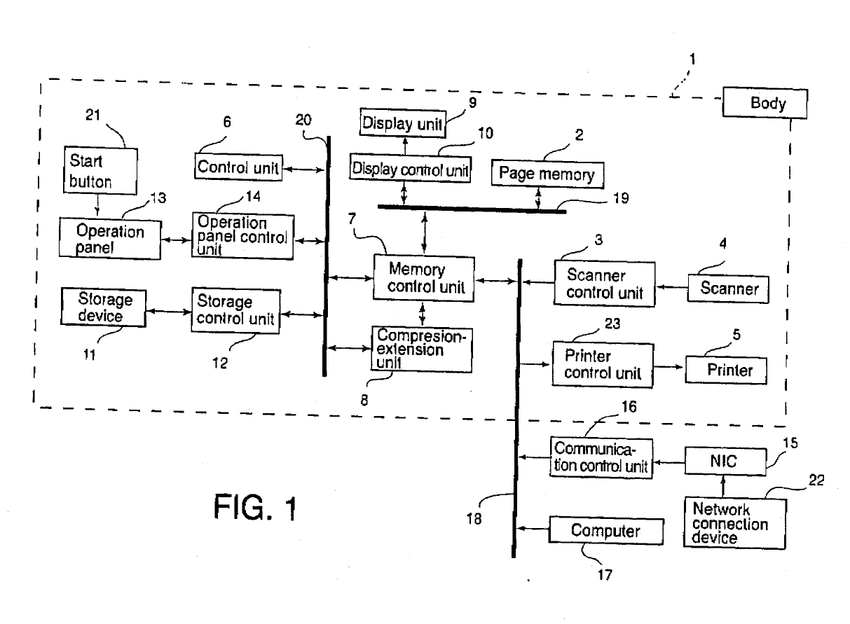

FIG. 1 is a block diagram of an image forming apparatus which is an image processing apparatus relating to the first embodiment of the present invention.

A document image is read by a scanner 4 which is an image input means accompanying a body 1 of the image forming apparatus and as document image data, sent to a scanner control unit 3 and to a memory control unit 7 via an image data bus 18

Further, also from a computer 17 directly connected to the body 1 and a network connection device 22 connected from an NIC (Network Interface Card) 15 connected to a network via a communication control unit 16, document image data can be sent to the memory control unit 7 via the image data bus 18. Furthermore, to the image data bus 18, a printer control unit 23 for controlling a printer 5 for recording an image on a sheet of paper is connected.

The memory control unit 7 is connected to, in addition to the image data bus 18, a page memory 2 which is a storing means and a memory bus 19 to which a display control unit 10 is connected.

The display control unit 10 reads image data from the page memory 2 and lets a display unit 9, which is a first display means, such as an LCD (Liquid Crystal Display) or a CRT (Cathode-Ray Tube, Braun tube) display images.

Further, the memory control unit 7 is also connected to an image conversion means for performing frequency conversion, compressing, extending, and then composing images and to a compression-extension device 8 which is a first compressing means, a second compressing means, a first extending means, and a second extending means.

Furthermore, the memory control unit 7 is connected to a system bus 20 together with the compression-extension device 8

To the system bus 20, in addition to them, an operation panel control unit 14 for controlling an operation panel 13, a storage control unit 12 for controlling a storage device 11 which is a storing means such as a HDD, and moreover a control unit 6 composed of a CPU and a ROM for controlling each control unit are connected

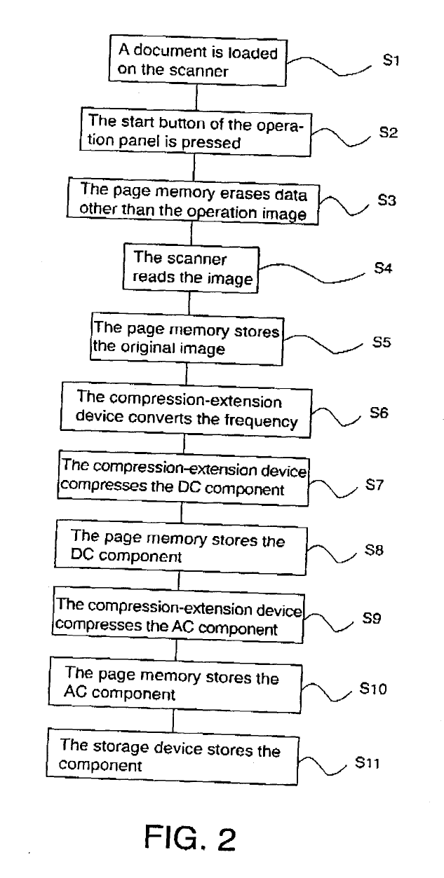

FIG. 2 is a flow chart of a storing process of document images read from the scanner 4. When a document is loaded on the scanner 4 (S1) and a start button 21 of the operation panel 13 is pressed (S2), a reading process of the loaded document is started as indicated below.

The data stored in the page memory 2 is erased with predetermined data left (S3) and the page memory 2 enters a state that it can store document image data sent from the scanner 4.

The predetermined data is data of an operation image such as a button, a line, and a character to be displayed, which are displayed on the display unit 9.

The data, which is generally stored in an independent, VRAM (Video Random Access Memory) is stored in the page memory. One memory is given a function of two memories, so that the number of memory ICs is reduced, thus a simplified structure can be realized.

The document image data read by the scanner 4 (S4) is stored once in the page memory 2 (S5).

Thereafter, from the document image sent to the compression-extension device 8, like an image frequency conversion compression method such as the JPEG method, data of the DC component which is direct current component (mean value) and data of the AC component which is an alternating current component (variation value) are extracted (S6). Here, assuming a rectangular area of 8×8 pixels as one block, by the discrete cosine conversion, the mean value of color data in one block, that is, the DC component and the differentia in each pixel, that is, the AC component are extracted.

The reason that one block is assumed as a rectangular area is that the discrete cosine conversion can be performed easily. When a method that the discrete cosine conversion is highly developed is used, areas in various shapes can be handled. However, document images read by the scanner 4 are mostly recorded on rectangular sheets of paper, so that dividing into rectangular areas is sufficient.

For the AC component required to store information of 8×8 pixels, the DC component is recommended to store information in correspondence to one pixel, which is a mean value of 8×8 pixels.

The DC component and AC component extracted, since an effective compression method is different between them, are respectively compressed by a different method (S7 and S9). After compression, the DC component and AC component are stored once in the page memory 2 (S8 and S10), related to each other as data in correspondence to one page, and stored in the storage device 11 (S11).

Image data in correspondence to one page can be filed by merging several pages.

As mentioned above, when the page memory 2 is provided with a function as a VRAM and their storage areas are handled as one area, an operation for moving the destination of referring to by the display control unit 10 for the data to be displayed on the thumbnail display position of the display unit 9 from the area storing an operation image on the page memory 2 to the area storing the DC component can be performed.

However, by use of a constitution that even if the page memory 2 and the VRAM are different from each other, their storage areas are handled as one area, although there is no advantage of simplification of the equipment constitution, this operation can be performed.

The reference destination of the display control unit 10 is just changed, so that transfer of large data is not accompanied with and display can be switched at high speed.

Further, the DC component is a mean value of 8×8 pixels and only one of the 8×8 pixels is stored, so that by referring to it, an image of 1/64 of the pixels of a document image can be obtained without performing the reduction process.

The reduction process and data transfer process are omitted, thus the display of a reduced image can be switched at high speed.

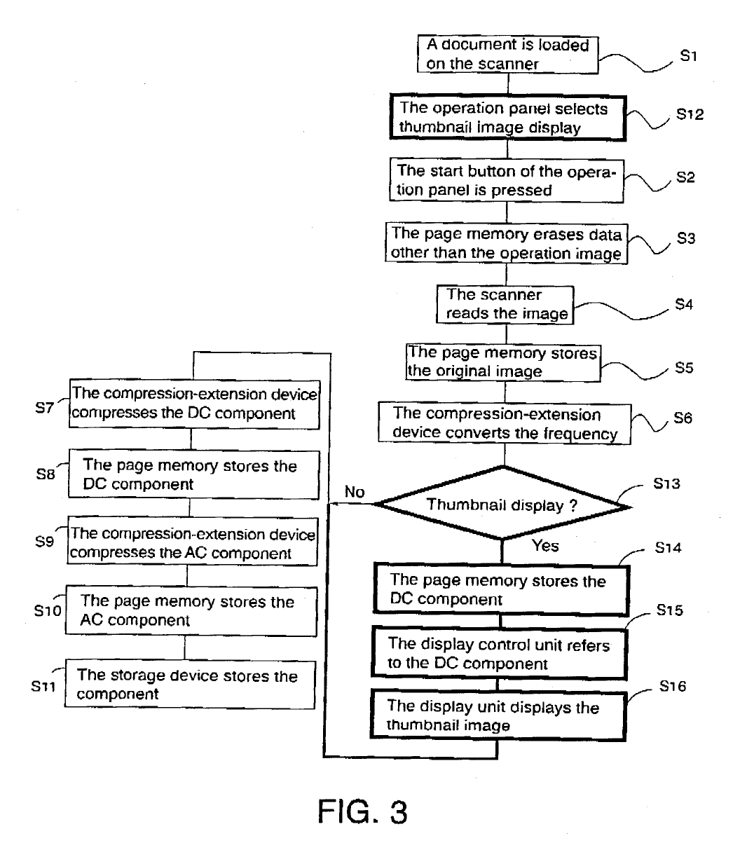

A flow chart when a process of displaying a thumbnail image is added to the flow of processing from reading to storing of the document image shown in FIG. 2 is shown in FIG. 3. When it is judged (S13) that selection of thumbnail display of the document image to be read from the scanner 4 by the display unit 9 (S12) is performed by the operation panel 13, the DC component extracted by frequency conversion is stored in the page memory 2 (S14), and the display control unit 10 refers to the area of the page memory 2 storing the DC component (S15), and the display unit 9 displays the DC component as an image (S16).

Without especially reading the DC component stored in the storage device, the DC component remaining in the page memory 2 can be displayed as a thumbnail image and the time required for data transfer between scanning and thumbnail image display is not required.

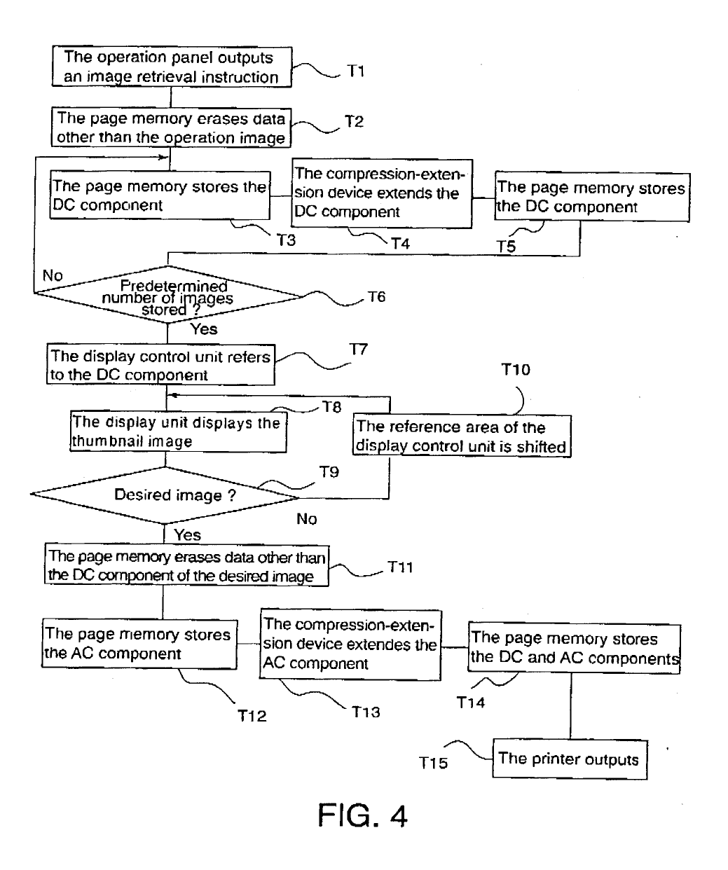

Next, a process of displaying a stored image as a thumbnail image and retrieving and printing a desired image will be explained by referring to FIG. 4.

When an instruction of displaying a thumbnail image and retrieving an image is output from the operation panel 13 (T1), the data in the page memory 2 is erased with the operation image left (T2).

The DC component kept compressed in the erased area is read once (T3), extended by the compression extension device 8 (T4), and stored again in the page memory 2 (T5).

Furthermore, in an empty area, the DC component of sequential images of a predetermined number before and after the aforementioned image is extended and stored in the same way (T6). Instead of a predetermined number, as many images as possible may be stored in the storage area.

When the display control unit 10 refers to this area (T7), a thumbnail image of 1/64 of the size of the document image can be displayed on the display unit 9 (T8).

Whether the displayed thumbnail image is a desired one or not is decided (T9) and when it is not the desired one, the area which the display control unit 10 refers to is shifted to the part where the next image is stored (T10).

The preceding and subsequent images are read in the page memory 2 beforehand, so that when a new image is read in the area where the image, which is referred to once and not judged as a desired image, is stored, image selection can be executed smoothly.

When the displayed thumbnail image is a desired one, the data other than the DC component of the image is erased (T11), and the residual DC component and the AC component which is read from the storage device 11 (T12) and extended by the compression-extension device 8 (T13) are composed (T14) and printed by the printer 5. Instead of printing on a sheet of paper like the printer 5, the composed data may be displayed, for example, on a high resolution LCD or CRT depending on the use.

To more increase the efficiency of image retrieval by display of a thumbnail image, it can be realized simply to make the thumbnail image smaller to display on the display unit 9 and increase the number of images, which can be read at one time. It can be realized by thinning data to be stored in the page memory 2 from the DC component, which is read from the storage device 11 and extended by the compression-extension device 8. Further, by storing the DC component in the page memory 2 without thinning and referring to by the display control unit 10 by skipping the data in the page memory 2 by one line and skipping the pixels in one line by one, an image of ¼ of the size of a thumbnail image can be obtained

The aforementioned can be applied to solution of a problem that the display unit 9 cannot display images unless the number of pixels of a thumbnail image is reduced at low resolution.

When the DC component and AC component are to be handled as one file, the following format is recommended.

At the top of the file, the data of the DC component is summarized, and then the data of the AC component is summarized, thus the data is stored. Before the DC component, a header including an identifier of the file form and the size of a document image may be provided.

The data size of the DC component is decided by the size of a document image and the number of block divisions Therefore, when the head address of the area stored in the file in the page memory 2 is obtained, it is recommended to read the DC component by the decided size and skip the AC component by the decided size from the head thereof, thus simple handling is realized.

It is an advantage of this form that since the DC component is summarized, simple thumbnail display is available.

As mentioned above, when a function for storing a document image, a function for mediating between the data of the compression-extension device and the storage device during the image compression-extension process, and a function as a VRAM are all given to the page memory, the number of memory chips can be reduced and the circuit can be made compact.

As an example of the file format, the format based on the JPEG method is cited above. However, the present invention is not limited to it and an image format of executing image frequency conversion and summarizing and connecting respectively the DC component and AC component thereof may be acceptable.

Furthermore, even if the DC component and AC component are stored in separate files, when the relating information thereof is stored separately, the image format can be used in the same way as with the image format aforementioned.

When, as separate files, the DC component is stored in a flash memory having little trouble and the AC component is stored in a large capacity storage such as a hard disk, even if the hard disk breaks down, what images are stored can be read immediately and the images can be discriminated quite obviously.

Next, the internal structure of a computer relating to the second embodiment will be explained.

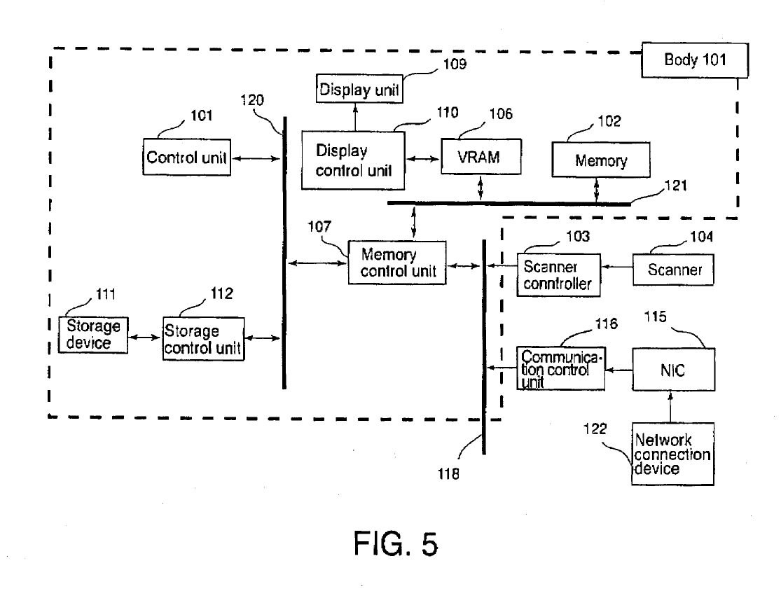

This embodiment, as shown in FIG. 5, is a one concerning the internal mechanism of a computer.

Image data read from a scanner 104 or an NIC 115 via a network is stored in a memory 102 and then subject to the frequency conversion operation. The image data is divided into a DC component and an AC component, then respectively summarized and compressed, and stored in a storage device 111.

When the stored image data is to be displayed as thumbnail images, only the DC component is read from the storage device 111 directly into a predetermined area of a VRAM 106 that the operation thereof is faster and the capacity thereof is smaller than those of the memory 102. The area is an area corresponding to the thumbnail image display position on a display unit 109.

When the original image of the displayed thumbnail image is to display, the AC component is read into the memory 102 from the storage device 111, and the AC component is composed and extended with the DC component stored in the VRAM 106 and stored in a predetermined position of the VRAM 106. As mentioned above, when a roll of reading the AC component image data is given to the memory 102 and more DC component image data is stored in the area of the VRAM 106 operating at high speed, a thumbnail image can be displayed at higher speed at the time of image retrieval and more comfortable image retrieval can be executed.

The present invention can provide an image processing apparatus capable of executing comfortable image retrieval and moreover can provide an image processing apparatus having a simplified equipment constitution round the data bus.

What is claimed is:

1. An image processing apparatus comprising:
image input means for inputting an image as image data; and
image conversion means for converting a frequency of said image data input from said image input means and extracting a DC component thereof.

2. The image processing apparatus according to claim 1, further comprising:
storing means for storing said image data input from said image input means,
wherein said image conversion means converts said frequency of said image data stored in said storing means and extracting said DC component and an AC component.

3. The image processing apparatus according to claim 2, wherein:
said image conversion means converts said frequency of said image data input from said image input means and extracts said DC component and said AC component therefrom; and
said storing means stores said DC component compressed by said first compression means and said AC component compressed by said second compression means by relating them to each other, further comprising:
first compression means for compressing said DC component extracted by said image conversion means;
second compression means for compressing said AC component extracted by said image conversion means;
first extension means for extending said DC component stored in said storing means;
second extension means for extending said AC component stored in said storing means;
first display means for displaying said DC component extended by said first extension means as an image; and
second display means for composing said DC component displayed by said first display means and said AC component which is stored in said storing means and extended by said second extension means and displaying them as an image.

4. The image processing apparatus according to claim 1, wherein said image conversion means converts said frequency of said image data input by said image input means and extracts said DC component therefrom, further comprising:
storing means for storing said DC component extracted by said image conversion means; and
display means for displaying said DC component stored in said storing means as an image.

5. The image processing apparatus according to claim 4, wherein:
said image conversion means divides said image data input by said image input means into data concerning N rectangular areas respectively composed of M pixels, converts said frequency for each said divided data, and extracts N DC components and M×N AC components; and
said display means displays said DC component stored in said storing means as an image of 1/M of the number of pixels of an image indicated by said image data.

6. The image processing apparatus according to claim 2, wherein said storing means stores said image data input from said image input means and said DC component extracted by said image conversion means.

7. The image processing apparatus according to claim 2, further comprising:
first compression means for compressing said DC component extracted by said image conversion means, and
second compression means for compressing said AC component extracted by said image conversion means,
wherein said storing means stores said image data input from said image input means, said DC component extracted by said image conversion means, said DC component compressed by said first compression means, and said AC component compressed by said second compression means.

8. An image processing method comprising the steps of:
inputting an image as image data,
converting a frequency of said input image data and extracting a DC component thereof; and
displaying said extracted DC component as an image.

9. The image processing method according to claim 8, further comprising the steps of:
dividing said image data into data concerning rectangular areas respectively composed of M pixels, converts said frequency for each said divided data, and extracts N DC components; and
displaying said extracted N DC components as an image of 1/M of the number of pixels of an image indicated by said image data.

10. The image processing method according to claim 8, further comprising the steps of:
converting said frequency of said input image data, extracting said DC component and an AC component, and storing said extracted DC component and said extracted AC component; and
displaying said stored DC component as an image and retrieving a desired image.

11. The image processing method according to claim 8, further comprising the steps of:
converting said frequency of said input image data and extracting said DC component and an AC component;
compressing said DC component;
compressing said AC component;
relating and storing said compressed DC component and said compressed AC component;
extending said stored DC component;
displaying said extended DC component as an image;
extending said displayed DC component and said related AC component; and
composing and displaying said extended AC component and said displayed DC component.

12. An image storing method comprising the steps of:
inputting an image as image data;
converting a frequency of said input image data and extracting a DC component thereof; and
storing said input image data and said DC component extracted after converting said frequency of said image data by same storing means.

13. The image storing method according to claim 12, further comprising the steps of:
converting said frequency of said input image data, extracting an AC component together with said DC component, compressing said extracted DC component, and compressing said extracted AC component; and
storing at least said DC component among said input image data, said extracted DC component, and said extracted AC component, and said compressed DC component, and said compressed AC component by same storing means.

14. The image storing method according to claim 13, further comprising the step of:
storing, after a first part that said extracted DC component is continuously summarized, a second part that said extracted AC component is continuously summarized.
